(19) United States
(12) Patent Application Publication
(10) Pub. No.: US 2008/0253357 A1
(43) Pub. Date: Oct. 16, 2008

(54) COMPUTER SYSTEM WITH INTERNET PHONE FUNCTIONALITY

(75) Inventors: Yu-Chih Liu, Taipei (TW); Yung-Lang Huang, Taipei (TW); Shu-Fen Chen, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: ASUSTEK COMPUTER INC., Taipei (TW)

(21) Appl. No.: 11/871,165

(22) Filed: Oct. 12, 2007

(30) Foreign Application Priority Data
Oct. 13, 2006 (TW) 95137674

(51) Int. Cl. H04L 12/66

(52) U.S. Cl. 370/352

(57) ABSTRACT

A computer system with internet phone functionality is provided. The computer system keeps running application programs when it turns the processing rate and the voltage of the central processor unit down (e.g. enter to the sleep mode). When the internet phone or a traditional telephone has an incoming call, the computer would be waked up immediately to prevent missing any incoming call from the internet phone or the traditional telephone.

### CROSS-REFERENCE TO RELATED APPLICATION

This application claims the priority benefit of Taiwan application serial no. 95137674, filed on Oct. 13, 2006. All disclosure of the Taiwan application is incorporated herein by reference.

### BACKGROUND OF THE INVENTION

1. Field of the Invention

The invention relates to a computer system and, more particularly, to a computer system with internet phone functionality and can wake up quickly.

2. Description of Related Art

With the progress of technology, the computer system (e.g. personal computer) has already been widely used in our lives. Furthermore, along with the popularity of the Internet, the internet phone appeared and gradually replaced the traditional telephone to be a cheap and convenient communication device.

Thus, some users is used to keeping personal computer (PC) 13 on in order to wait for incoming calls of the internet phone. However, electric power consumption of computer is huge comparing to other household appliances, so this practice is costly at present with high energy price.

In order to save electricity, some users turn on the PC 13 when they need to make an internet phone call and turn off the PC 13 after finishing the internet phone call. However, the PC 13 could not receive incoming calls of the internet phone, and the user would get tired waiting for the power-on procedure of the PC 13. Generally speaking, time for turning on the PC 13 is about 30 seconds long which is much longer than the other household appliances. It is considerably inconvenient for users to wait so long for turning on the PC nowadays.

Therefore, users may set the PC 13 to automatically enter the sleep mode when there is no incoming call. There are a normal operating state S0 and sleep states S1, S3, S4, and S5 in the sleep mode. At state S0, all devices are turned on and operated normally. At state S1, the setting value of all devices (e.g. central processing unit, chipset, and other devices) would not be lost; only the display and the audio-source-output device of the computer system would be turned off so that the operating state would be restored quickly. At state S3, all of the setting values of the devices are stored in the random access memory (RAM) and restored to the devices when returning to the operation state. At this state, devices are turned off except for some devices such as standby-power-source and RAM. At state S4, setting value of all the devices is stored in the hard disk and restored to the devices from the hard disk when returning to the operation state. The state S5 is the power-off state. Generally speaking, to restore from the sleep mode S1 or S3 to normal operating state, operation system of PC 13 must wake up the PC through other devices or System Management Interrupt (SMI)/System Control Interrupt (SCI) event. Caller of the internet phone sometimes hangs up or the receiver misses the moment to answer the phone because of so long time waited for during the PC enter the normal operating state from the sleep mode. For example, when Skype or other instant communication software (e.g. Google Talk, Windows Live Messenger, etc.) is used on the PC 13 and the PC 13 is at the sleep mode, users may often miss the moment to answer the incoming call of the internet phone because of the long time cost to enter the normal operating state from the sleep mode.

Moreover, when making an internet phone call, users must further operate the PC (e.g. move the mouse, press the keyboard, etc.) to wake up the PC if it is at the sleep mode.

In view of these, all the relevant manufacturers of the computer are eager to find suitable solution to solve problems illustrated above.

### BRIEF SUMMARY OF THE INVENTION

The objective of the invention is to provide a computer system with internet phone functionality. When a call is coming, the computer system may wake up immediately to prevent missing the call. Moreover, when making an internet phone call by a telephone, a user may wake up the host at the sleep mode immediately.

To achieve the above or other objectives, the invention provides a computer system with internet phone functionality; the computer system includes an Internet module, a host, and a telecom adapter module. The Internet module is used for providing the computer system connecting to the Internet and transmitting data. The host couples to the Internet module and may run an internet phone application program, wherein, when the host enters to the sleep mode, the setting value of the central processing unit (CPU) therein is stored in the memory and the internet phone application program is kept running on the host. When the internet phone application program receives a communication request message, the host restores setting value in the memory to the CPU and turns the processing rate and the voltage of the CPU up.

According to a preferred embodiment of the invention, the computer system further includes a telecom adapter module, which includes a Data Access Arrangement (DAA) unit, a Subscriber Line Interface Circuit (SLIC) unit, an audio codec, and a switch. The audio codec couples to the DAA unit, the SLIC unit, and the connection interface, to transform analog voice signals into digital voice signals or digital voice signals into analog voice signals. The switch of the telecom adapter module connects with the first connection port, the second connection port, the DAA, and the SLIC unit. The connection status among the first connection port, the second connection port, DAA unit, and the SLIC unit may be switched by control of the telecom adapter module.

According to the embodiment of the invention, the computer system with internet phone functionality also may wake up by other events such as users operating the telephone.

As illustrated above, because the invention applies a computer system with internet phone functionality, the computer system keeps running the internet phone application programs when it turns the processing rate and the voltage of the CPU lower. When there is an incoming call from the internet phone or the traditional telephone, the computer system may wake up quickly to prevent missing the call. Moreover, when users need to make an internet phone by a telephone, the computer system may wake up the host from the sleep mode by the motion of operating the traditional telephone instead of other computer devices.

These and other objectives, features, and advantages of the present invention will become better understood with regard to the following description, claims, and accompanying drawings.

### BRIEF DESCRIPTION OF THE DRAWINGS

FIG. 1 shows a known way that an internet phone adapter box connects with a traditional telephone and a PC to make the traditional telephone may make a web call.

FIG. 2 is a block diagram of a computer system with internet phone functionality according to the embodiment of the invention.

FIG. 3 is a block diagram of the host of the computer system with internet phone functionality according to the embodiment of the invention.

FIG. 4 is a block diagram of a telecom adapter module of the computer system with internet phone functionality according to the embodiment of the invention.

FIG. 5 is a flowchart that the computer system enters the sleep mode according to the embodiment of the invention.

FIG. 6 is a flowchart that the computer system wakes up when there is an incoming call from the internet phone according to the embodiment of the invention.

FIG. 7 is a flowchart that the computer system wakes up when there is an incoming call from the telecom network according to the embodiment of the invention.

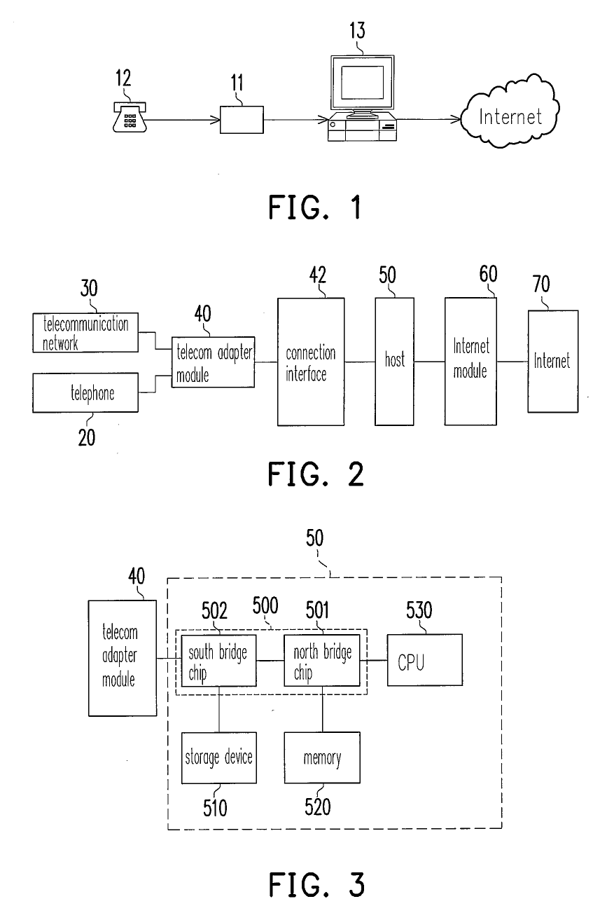

### DETAILED DESCRIPTION OF THE INVENTION

In the embodiments of the following description, when an element is described as “connecting” or “coupling” to another element, it may connect or couple to another element directly or with other element(s) existing between them (indirectly).

FIG. 2 is a block diagram of the computer system with internet phone functionality according to the embodiment of the invention. Refer to FIG. 2. the architecture of the embodiment includes a telephone 20, a telecom network 30, a telecom adapter module 40, a connection interface 42, a host 50, an Internet module 60, and the Internet 70. The telephone 20 may be a traditional telephone, and the telecom network 30 may be the Public Switch Telephone Network (PSTN). In the embodiment, a connection interface 42 may be a Universal Serial Bus (USB) interface.

FIG. 3 is a block diagram of the host of the computer system with internet phone functionality according to the embodiment of the invention. Refer to FIG. 3. The host 50 includes chipset 500, a storage device 510, a memory 520, and a central processing unit (CPU) 530.

The chipset 500 further includes a north bridge chip 501 and a south bridge chip 502. The north bridge chip 501 couples between the CPU 530 and the south bridge chip 502. The memory in the host 50 couples to the north bridge chip 501 and is used for saving data and application programs during the operation of the CPU. The north bridge chip 501 is used for communicating with the CPU 530, controlling reading and/or writing of the memory 520, controlling the bus (not shown), and transmitting data to/from the south bridge chip, etc. the south bridge chip 502 couples to the telecom adapter module 40, the Internet module 60, and the storage device 510, respectively. The south bridge chip 502 is mainly used for communicating with the output/input interface and peripheral devices. The CPU 530 may execute varies kinds of application program instructions. Moreover, the storage device of the host 50 couples to the south bridge chip 502. The storage device 510 may be other nonvolatile storage device, such as flash memory. The storage device 510 may store an operating system (OP), image and audio data, internet phone software, an application program relevant to a telecom adapter module 40, or other application programs.

The Internet module 60 may connect to the Internet 70 wiredly or wirelessly to provide the host 50 with the function of accessing Internet. In the embodiment, the Internet module 60 may be an Ethernet card. In other embodiments, the Internet module 60 also could be a wireless network card. Therefore, the host 50 may access Internet 70 through the Internet module 60, and run the internet phone application program (e.g. Skype) and/or the application programs relevant to the telecom adapter module 40 (e.g. ASUS TalkyGuru), such that users may make or receive the internet phone through the telephone 20.

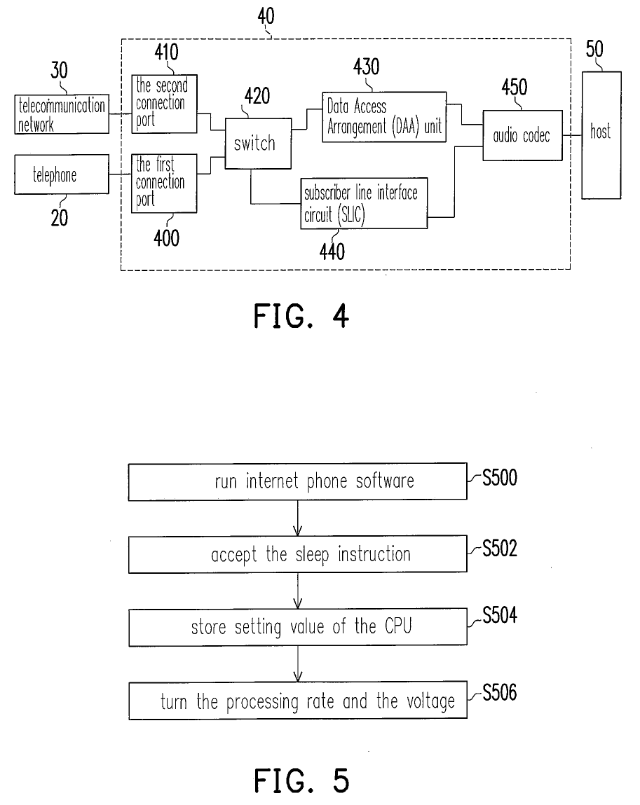

FIG. 4 is a block diagram of the telecom adapter module of the computer system with internet phone functionality according to the embodiment of the invention. Refer to FIG. 4. the telecom adapter module 40 includes a first connection port 400, a second connection port 410, a data access arrangement (DAA) unit 430, a Subscriber Line Interface Circuit (SLIC) unit 440, and an audio codes 450. The first connection port 400 may couple with the telephone 20, and the second connection port 410 of the telecom adapter module 40 may couple with the telecom network 30. Moreover, telecom adapter module 40 may couple with the south bridge chip 502 through the connection interface 42. In the embodiment, both the first connection port 400 and the second connection port 410 are RJ11 connection ports. In other embodiments, the first telecom connection port 400 and the second telecom connection port 410 also may be other types of connection port.

In the embodiment, the DAA unit 430 may provide functions of power charging and analog-telephone simulating to receive a PSTN phone call. The SLIC unit 440 may provide power and dialing tones, detect the close loop formed by the telephone 20, and transfer the data packets of the internet phone into the analog signals of the telecom network 30.

In the embodiment, the audio codec 450 couples to the DAA unit 430, SLIC unit 440, and the connection interface 42 to transfer analog voice signals into digital voice signals or transfer digital voice signals into analog voice signals. The switch 420 of the telecom adapter module 40 connects to the first connection port 400, the second connection port 410, the DAA unit 430, and the SLIC unit 440. The switch 420 switches the connection status among the second connection port 410, the DAA unit 430, and the SLIC unit 440 according to the control of the audio codec 450.

In the embodiment, the telecom adapter module 40 is an expansion card inserted on the motherboard of the computer device. In other embodiments, the telecom adapter module 40 also may be integrated on the motherboard. In the embodiment, the connection interface 42 is a USB. In other embodiments, the connection interface 42 also may be IEEE 1394 interface, a Peripheral Component Interconnect (PCI), PCI Express, AC97, or Azalia interface.

In traditional telephone mode, the first connection port 400 electrically connects to the second connection port 410 after the switching of the switch 420, so that the telephone 20 may make a phone to the telecom network 30 or receive an incoming call from the telecom network 30. In the internet phone mode, the first connection port 400 electrically connects to the DAA unit 430 after the switching of the switch. The telephone 20 connected to the Internet 70 may make an internet phone through the telecom adapter module 40, the connection interface 42, the host 50, and the Internet module 60. In the internet phone mode, the first connection port 400 electrical connects the SLIC unit 440, the telephone 20 connected to the Internet 70 may make an internet phone through the telecom adapter module 40, the connection interface 42, the host 50, and the Internet module 60. The following will specify an embodiment of making and/or receiving a phone when the host 50 enters the sleep mode.

FIG. 5 is a flowchart that the computer system enters the sleep mode according to the embodiment of the invention. Please refer to FIG. 5. First of all, in step S500, the host runs the internet phone application program (e.g. Skype) and/or application programs relevant to the telecom adapter module 40 (e.g. ASUS TalkyGuru) to facilitate the users to make or receive an internet phone via the telephone 20 and the computer system. In step S502, the host 50 enters into a sleeping mode. The host 50 may be set to enter into the sleeping mode automatically after idling for a period of time. Persons having ordinary skill in the art may change the mode of practice according to the spirit of the invention and teachings of the embodiments described above in view of actual needs. For example, a button may be used for sending a sleeping instruction after being pressed. Infrared devices may also be used to send the sleeping instruction to the computer system. The details are omitted here for concise purpose.

After the host 50 enters the sleep mode, the step S504 stores the setting value of the CPU 530 of the host 50 in the memory 520 and turns the processing rate and the voltage of the CPU 530 lower (step S506). At the state of the sleep mode, the telecom adapter module 40 still has normal power supply, such as the 5V voltage supplied by USB. Persons having ordinary skill in the art may change the mode of practice according to the spirit of the invention and indication of the embodiments described above in view of the actual needs. For example, when the host 50 enters the sleep mode, the setting values of peripheral devices such as the fan and the clock generator are stored in the memory 520. After saving the setting value of the devices, the host 50 turns their rate lower. The function of the fan is heat dissipation, and the CPU 530 is one of the main heat sources. After the processing rate of the CPU 530 is turned down, the need of heat dissipation is lower, too. Therefore, the rate of the fan may be turned down according to the processing rate of the CPU 530 to not only dissipate heat but also save electricity and reduce noise. When entering the sleep mode, the host 50 may store the setting value of the audio output device and the display in the memory 520, and turn off these devices after saving the setting value or keep them alive in view of actual needs.

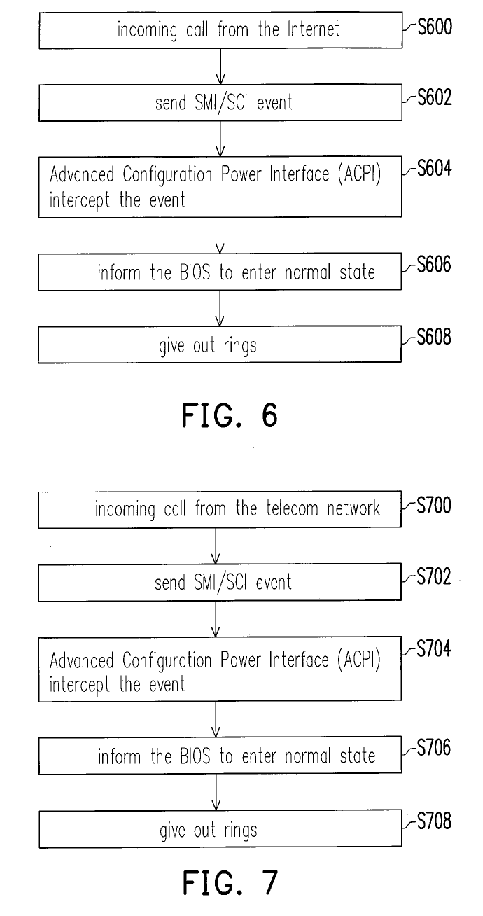

FIG. 6 is a flowchart that the computer system wakes up when there is an incoming call from the internet phone according to the embodiment of the invention. Refer to FIG. 6. In the step S600, the internet phone application program receives a communication request message when there is an incoming call from the Internet. If the host 50 is at the sleep mode, the Internet module 60 would send an SMI/SCI event to the south bridge chip 502 (step S602), and the south bridge would send an event to the computer system. The interface of the Advanced Configuration Power Interface (ACPI) would intercept the event (step S604) and inform the Basic Input/Output System (BIOS) to enter normal operating state (step S606). In the step S608, the Internet module 60 and the ASUS Talky Guru software send a dial signal to make the telephone give out rings, so as to inform users the incoming call. Persons having ordinary skill in the art may run relevant application programs to add some extra functions by the computer system when the computer system restores to the normal operating state for meeting the need. For example, show the number of the incoming call, check that if the number exists in the blacklist, and decide to block it or not; play tones relevant to the number of incoming call to remind users to answer it; automatically re-route the incoming call when there is no answer; start the voice message program and store it in the hard disk. They will not be described further for concise purpose.

FIG. 7 is a flowchart that the computer system wakes up when there is an incoming call from the telecom network according to the embodiment of the invention. Refer to FIG. 7. The computer system entering the sleep mode is the same as steps of the embodiments illustrated above, which is not described for concise purpose. In the step S700, the internet phone application program also receives a communication request through the telecom adapter module 40 and the ASUS Talky Guru software, when there is an incoming call from the traditional telecom network 30. At the same time, the telecom adapter module 40 sends an event to the south bridge chip 502 through the connection interface 42 (e.g. USB interface), and the south bridge also sends an SMI/SCI event to the computer system (step S702). In the step S704, the ACPI interface intercepts the event and informs the BIOS to enter the normal operating state SO (step S706). The telephone gives out rings (step S708). When not nearing at the computer, users may operate the ASUS Talky Guru software to leave a voice message or other setting functions by long-range controlling, such as re-routing the incoming call. They will not be described for concise purpose. When restoring to the normal operating state, the computer system may run some relevant programs as embodiments illustrated above. They will not be described for concise purpose.

According to the embodiment of the invention, the computer system enters the sleep mode as the embodiments illustrated above. They will not be described for concise purpose. When picking up the telephone 20, users may send an event, utilizing the telecom adapter module 40 and the ASUS Talky Guru software through the connection interface 42 (USB interface), to the south bridge chip 502. Users may wake up the computer system at the sleep mode as illustrated above through directly operation to make the internet phone call instead of using the peripheral devices, such as the mouse, the keyboard, wherein also including making a traditional phone call. Persons having ordinary skill in the art also may run the relevant application programs by the host 50 to add some extra functions in view of the actual needs. For example, display the phone book; provide scheduler and notepad; whether run the record program to provide users to record contents of the conversation on the hard disk. They will not be described for concise purpose.

In summary, because the invention uses a computer system with internet phone functionality, the computer system may keep the application programs running when turning the processing rate and the voltage of the CPU lower. Therefore, the telephone may receive and/or make the internet phone even when the computer enters the sleep mode. When there is an incoming call from the internet phone or the traditional telephone, the computer system may wake up quickly to prevent missing the call. Moreover, when users need to make an internet phone call by a telephone, the computer system may wake up the host from the sleep mode by motion of operating the traditional telephone instead of other computer devices.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What's claimed is:

1. A computer system with internet phone functionality, comprising:
an Internet module for connecting the computer system to the Internet; and
a host coupling with the Internet module and being able to run an internet phone application program, wherein when the host enters a sleep mode, a setting value of a central processing unit (CPU) in the host is stored in a memory, the processing rate and the voltage of the CPU are turned lower, and the internet phone application program runs on the host keeps running;
wherein when the internet phone application program receives a communication request message, the host restores the setting value stored in the memory to the CPU and turns the processing rate and the voltage of the CPU higher.

2. The computer system with internet phone functionality according to claim 1, further comprising a telecom adapter module, which comprises a first connection port for coupling with a telephone and a second connection port for coupling with a telecom network, wherein the telecom adapter module couples with the host via a connection interface so that the telephone makes and receives an internet phone through the telecom adapter module, the host, and the Internet module.

3. The computer system with internet phone functionality according to claim 2, wherein the host comprises a chipset coupling with the CPU, wherein the chipset couples with the telecom adapter module via the connection interface.

4. The computer system with internet phone functionality according to claim 3, wherein the chipset comprises a north bridge chip and a south bridge chip, the north bridge chip couples between the CPU and the south bridge chip.

5. The computer system with internet phone functionality according to claim 4, wherein the memory couples with the north bridge chip.

6. The computer system with internet phone functionality according to claim 4, wherein when the internet phone application program receives the communication request message, an advanced configuration power interface (ACPI) of the computer system intercepts a SMI/SCI event send by the south bridge chip, to restore the setting value to the CPU.

7. The computer system with internet phone functionality according to claim 2, wherein the connection interface comprises a universal serial bus interface.

8. The computer system with internet phone and traditional telephone functionality according to claim 2, wherein the telecommunication adapter module further comprising:
a data access arrangement (DAA) unit;
a subscriber line interface circuit (SLIC) unit;
an audio codec coupling with the DAA unit, the SLIC unit, and the connection interface for transforming analog voice signals into digital voice signals or transforming digital voice signals into analog voice signals; and
a switch, connecting with the first connection port, the second connection port, the DAA, and the SLIC unit for switching between a traditional telephone mode and an internet phone mode by switching the connection relationship between the first connection port, the second connection port, the DAA unit, and the SLIC unit according to the control of the telecom adapter module.

9. The computer system with internet phone functionality according to claim 8, wherein in the traditional telephone mode, the first connection port is electrically connected to the second connection port by switching of the switch.

10. The computer system with internet phone functionality according to claim 8, wherein in the internet phone mode, the first connection port is electrically connected to the DAA unit by switching of the switch whereby the telephone makes the internet phone through the telecom adapter module, the host, and the Internet module.

11. The computer system with internet phone functionality according to claim 8, wherein in the internet phone mode, the first connection port is electrically connected to the SLIC unit by switching of the switch whereby the telephone receives the internet phone through the telecom adapter module, the host, and the Internet module.

12. The computer system with internet phone functionality according to claim 2, wherein when the internet phone application program receiving the communication request message, the host restores the setting value stored in the memory to the CPU, and turns the processing rate and the voltage of the CPU higher.

13. The computer system with internet phone functionality according to claim 2, wherein when users operate the telephone, the host restores the setting value stored in the memory to the CPU, and turns the processing rate and the voltage of the CPU higher.
